(19) United States
(12) Patent Application Publication
(10) Pub. No.: US 2009/0242353 A1
(43) Pub. Date: Oct. 1, 2009

(54) BILL ACCETOR

(75) Inventors: Cheng-Kang Yu, Taipei (TW); Wei-Jr Chen, Taipei (TW); Shih-Chia Chen, Taichung (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Taipei City (TW)

(21) Appl. No.: 12/058,761

(22) Filed: Mar. 31, 2008

(51) Int. Cl. G07F 7/04

(52) U.S. Cl. 194/207; 194/206

(57) ABSTRACT

A bill acceptor in which a bill box has a baffle pivoted to the box body thereof at one side of a bill entrance of the box body and torsional springs bilaterally coupled between the baffle and the box body to bias the baffle toward a spring-supported bill-receiving bearing board inside the bill box so that the baffle allows a inserted bill to be moved onto the bill-receiving bearing board by a bill-pressing device in a bill acceptor main unit of the bill acceptor and immediately holds the bill positively on the bill-receiving bearing board after retrieval of the bill-pressing device.

### BACKGROUND OF THE INVENTION

1. Field of the Invention

The present invention relates to a bill acceptor and more specifically, to an improved structure of bill box for bill acceptor, which uses a torsional spring-supported baffle to hold down each received bill positively on the bill-receiving bearing board inside the bill box.

2. Description of the Related Art

Following fast development of technology, our mode of living has been changed and different automatic vending machines are used everywhere to sell different products without serviceman. These automatic vending machines are highly invited for the advantage of saving much labor and bringing convenience to people.

Further, a Q-shop has the advantages of scientific intelligence, quick service, and quick finish of payment. A Q-shop may provide automatic vending machines for vending drinks, cigarettes, tickets, ice creams, memorial coins, key rings, or even hamburgers and noodles. Nowadays, many virtual shops are established to make online shopping, allowing shoppers to shop across millions of products.

Further, an automatic vending machine generally uses a bill acceptor to receive and verify the authenticity and value of the inserted bill. An advanced bill acceptor has an insertion slot for the insertion of bill and license, and recognition means to identify the age of the license holder of the inserted license so that the automatic vending machine controls selling of controlled items.

Further, a bill acceptor uses a bill-pressing device to move the inserted bill away from the bill passage to the inside of the bill box, enabling received bills to be stacked on a bill-receiving bearing board inside the bill box. However, when the bill-receiving bearing board of the bill box receives a wrinkled or folded bill, the wrinkled or folded bill may drop out of the bill box after retrieval of the bill-pressing device.

Therefore, it is desirable to provide a bill acceptor with an improved structure of bill box that eliminates the aforesaid problem.

### SUMMARY OF THE INVENTION

The present invention has been accomplished under the circumstances in view. It is one object of the present invention to provide a bill acceptor for use in an automatic vending machine for receiving and verifying bills, which has means to hold down each received bill positively on the bill-receiving bearing board inside the bill box.

To achieve this and other objects of the present invention, the bill acceptor comprises a bill acceptor main unit and a bill box fastened to the bill acceptor main unit. The bill box comprises a box body defining a bill entrance, and a bill-receiving bearing board suspended inside the box body and movable forwards/backwards relative to the bill entrance. The bill acceptor main unit comprises an insertion slot for the insertion of a bill, a passage in communication between the insertion slot and the bill entrance, and a bill-pressing device for moving each inserted bill away from the passage through the bill entrance onto the bill-receiving bearing board. The bill box further comprises a baffle pivoted to the box body and suspending in the entrance at one side. The baffle has a rib that allows each bill to be moved from the passage over the baffle toward the bill-receiving bearing board by the bill-pressing device. When a bill is moved over the baffle by the bill-pressing device and received at the bill-receiving bearing board, the rib of the baffle presses the bill on the bill-receiving bearing board, holding the bill positively in place.

### BRIEF DESCRIPTION OF THE DRAWINGS

FIG. 1 is an elevational view of a bill acceptor according to the present invention.

FIG. 2 is an exploded view of the bill acceptor shown in FIG. 1.

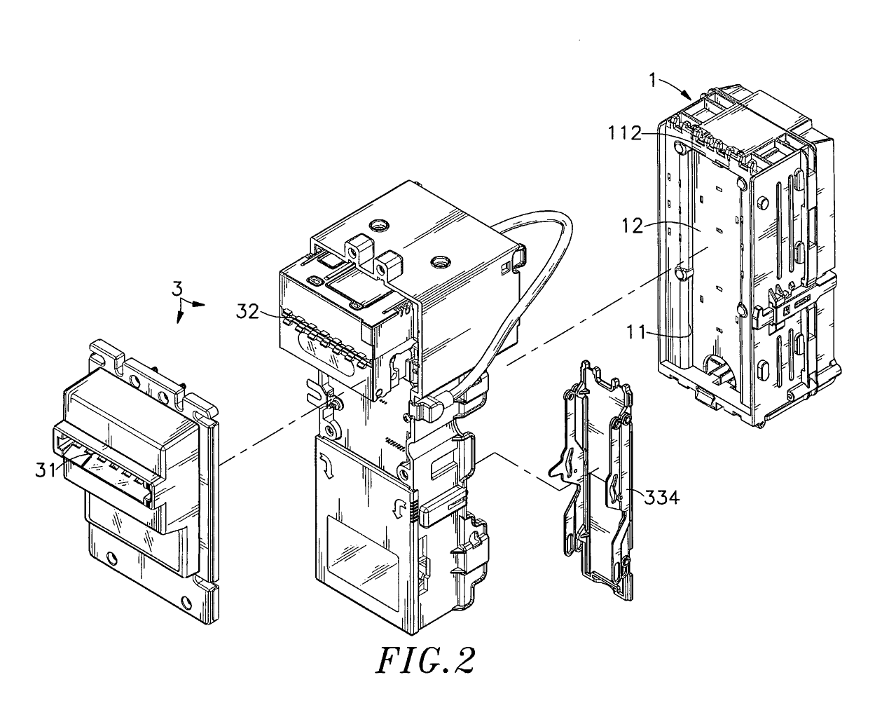

FIG. 3 is a sectional side view of the bill acceptor shown in FIG. 1.

FIG. 4 is in an enlarged view of a part of FIG. 3.

FIG. 5 is an exploded view of the bill box used in the bill acceptor shown in FIG. 1.

FIG. 6 is a sectional side view of the bill box in accordance with the present invention.

FIG. 7 is a sectional elevation of a part of the bill box, showing a bill stopped at the rib of the baffle.

FIG. 8 is a sectional side view of the present invention, showing a stack of bills received in the bill box and the rib of the baffle pressed on the stack of bills.

FIG. 9 is a sectional side view of the present invention, showing a stack of bills received in the bill box and the bill-pressing device returned to its former position.

### DETAILED DESCRIPTION OF THE PREFERRED EMBODIMENT

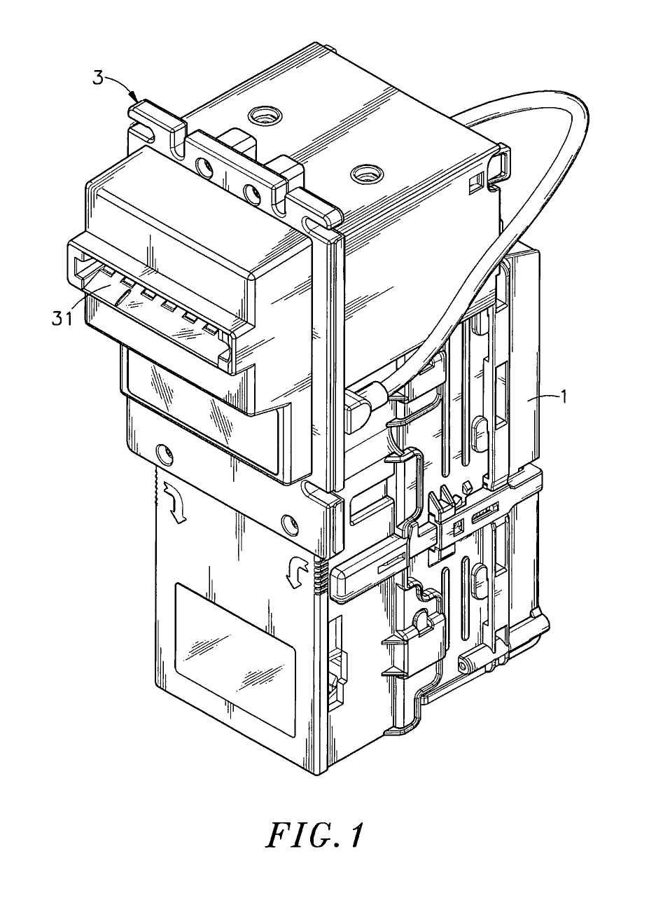

Referring to FIGS. 1˜5, a bill box in accordance with the present invention is shown comprising a box body 1 and a baffle 2 for stopping bills 4.

The box body 1 is installed in a bill acceptor main unit 3, having a bill entrance 11 that faces a bill-pressing device 334 of the bill acceptor main unit 3, a bill-receiving bearing board 12 suspended on the inside and movable inwards and outwards relative to the bill entrance 11, and spring members 13 that support the bill-receiving bearing board 12 and impart a pressure to the bill-receiving bearing board 12 toward the bill entrance 11. The bill-receiving bearing board 12 has a size slightly greater than the bill entrance 11 so that the bill-receiving bearing board 12 can be stopped against the inner side of the bill entrance 11. The box body 1 further has a recessed hole 111 on the outside adjacent to one side of the bill entrance 11, and a locating block 112 mounted in the recessed hole 111.

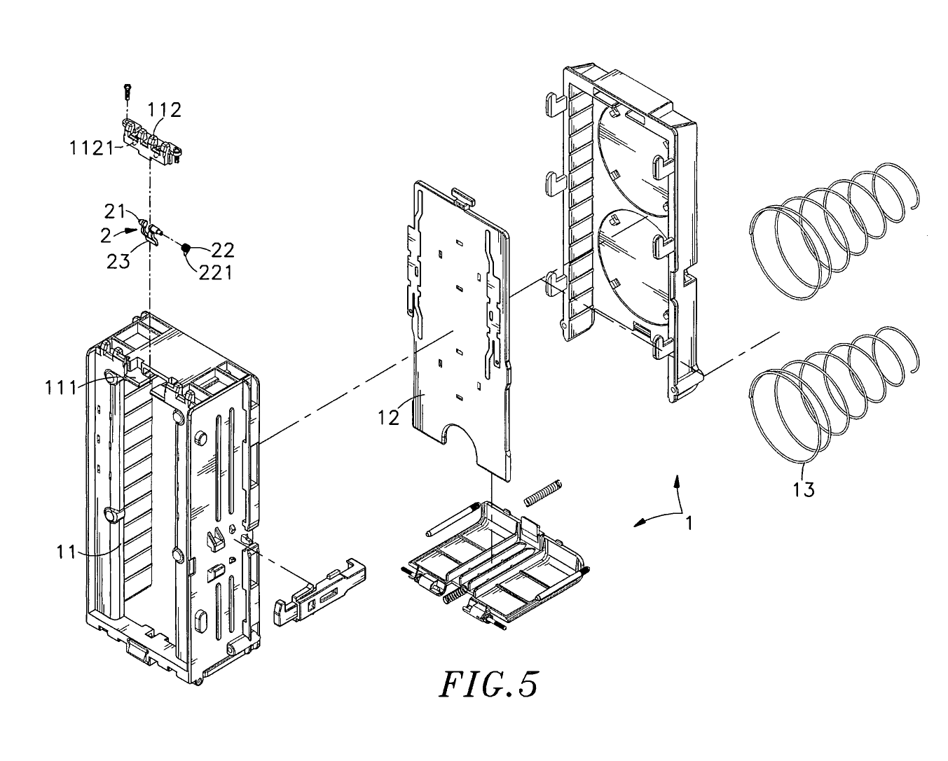

The baffle 2 has two pivot pins 21 respectively pivoted to a respective pivot hole 1121 on the locating block 112 (see FIG. 5). Two torsional springs 22 are respectively mounted on the pivot pins 21, each having two opposite ends 221 respectively fastened to the bottom side of the locating block 112 and the baffle 2. The baffle 2 further has a rib 23 projecting into the inside of the box body 1. The torsional springs 22 impart a pressure to the baffle 2, forcing the rib 23 against the surface of the bill-receiving bearing board 12.

When in use, the box body 1 is fastened to the bill acceptor main unit 3 at one side relative to the bill-pressing device 334. The bill acceptor main unit 3 comprises a bill insertion slot 31, a bill passage 32 extending from the bill insertion slot 31, a bill transfer mechanism unit 33 arranged at two sides relative to the bill passage 32 and adapted for transferring each inserted bill 4 from the bill insertion slot 31 through the bill passage 32 to the rear end of the bill passage 32. The bill transfer mechanism unit 33 comprises a motor 331, a set of bill-transfer rollers 332, a bill-transfer belt 333, and the aforesaid bill-pressing device 334.

An encoder wheel 3311 and an optical sensor 3312 are arranged in the bill acceptor main unit 3 and adapted for counting the number of turns of the bill-transfer rollers 332 that is indicative of the revolving speed of the bill-transfer rollers 332. Subject to the number of turns counted, the moving distance of the inserted bill 4 is known.

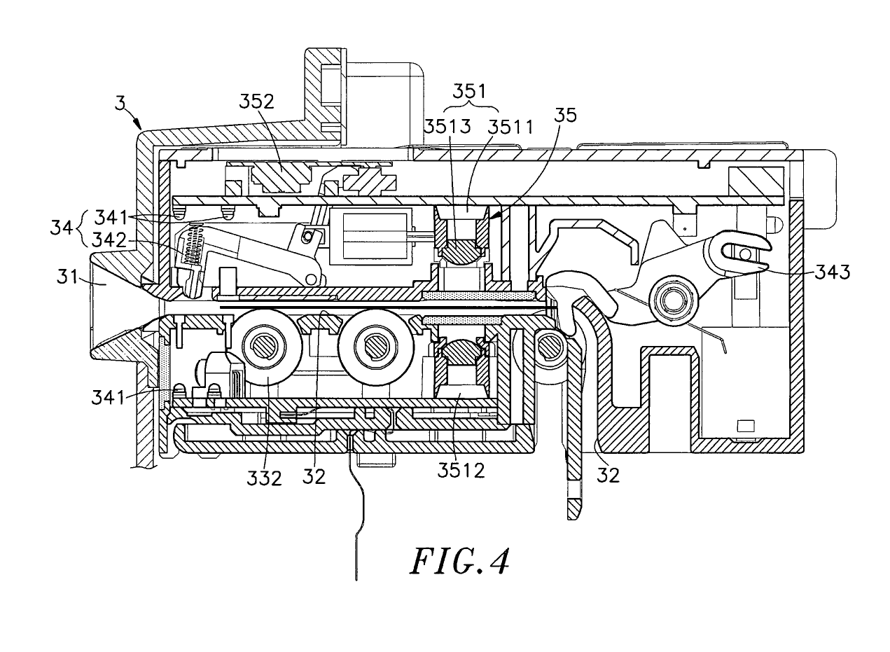

The bill acceptor main unit 3 further comprises a detection unit 34 disposed around the front side of the bill passage 32, and a recognition unit 35 disposed at top and bottom sides relative to the bill passage 32 (see FIG. 4). The detection unit 34 comprises a plurality of sensor switches 341, a light-shielding gate 342 and an anti-theft hook 343. The recognition unit 35 comprises an optical recognition module 351. The optical recognition module 351 comprises a plurality of light emitting devices 3511, a plurality of optical sensors 3512 respectively axially aimed at the light emitting devices 3511, and lenses 3513 respectively set between the light emitting devices 3511 and the optical sensors 3512 near the bill passage 32.

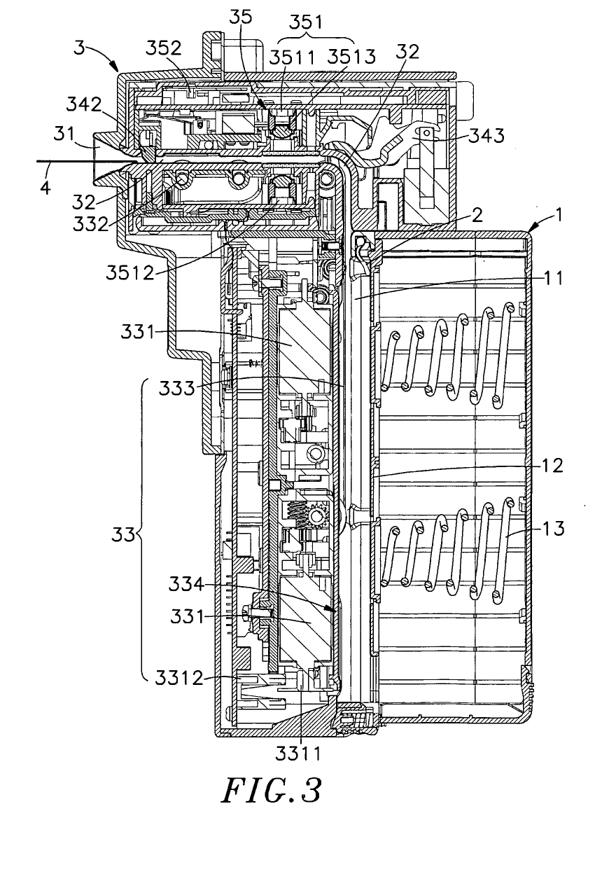

Referring to FIGS. 3˜5 again, the bill acceptor main unit 3 and the bill box that is formed of the aforesaid the box body 1 and the baffle 2 are fastened together, forming a bill acceptor for use in an automatic vending machine.

When a bill 4 is inserted into the bill insertion slot 31 of the bill acceptor main unit 3 into the bill passage 32, the inserted bill 4 shields the sensor switches 341, causing the sensor switches 341 to open the light-shielding gate 342 and to switch on the bill transfer mechanism unit 33 and the recognition unit 35. When the light-shielding gate 342 is opened, the bill 4 can then be inserted into the bill passage 32. At this time, the motor 331 drives the bill-transfer rollers 332 and the bill-transfer belts 333 to transfer the inserted bill 4 forwards. When the bill 4 passed over the light-shielding gate 342, on of the sensor switches 341 at a back side relative to the light-shielding gate 342 immediately close the light-shielding gate 342, avoiding external light from interfering with the recognition functioning of the recognition unit 35.

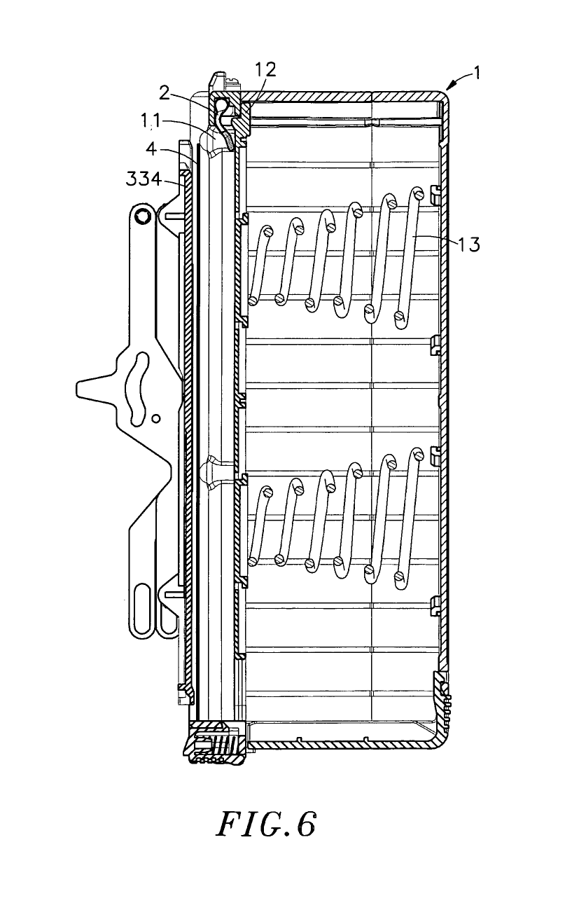

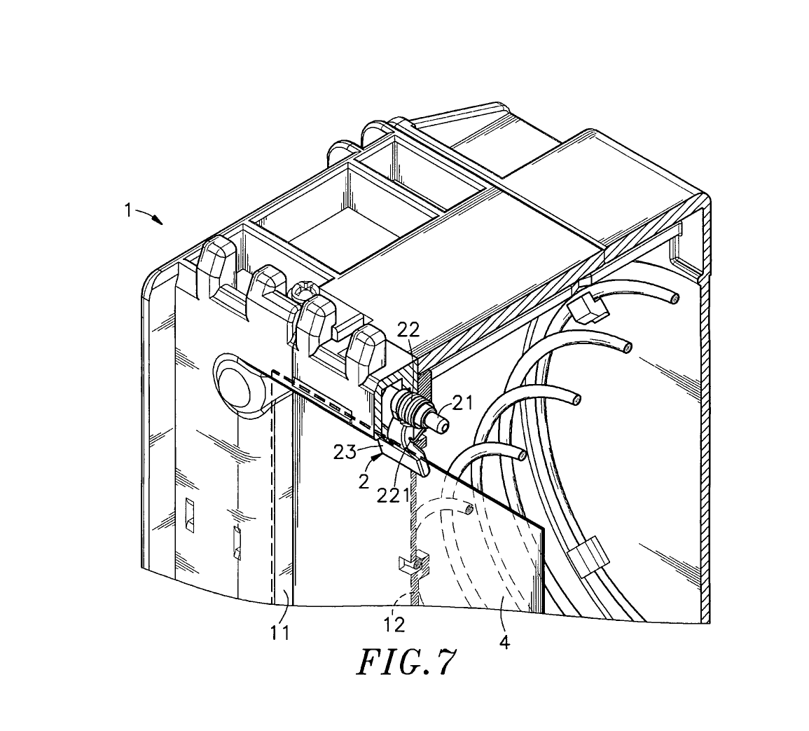

When the inserted bill 4 is recognized by the recognition unit 35 to be a real bill, the bill transfer mechanism unit 33 is driven to transfer the bill 4 to the rear end of the bill passage 32 between the bill-pressing device 334 and the box body 1 (see FIGS. 6 and 7). When the bill 4 reached the rear end of the bill passage 32 between the bill-pressing device 334 and the box body 1, the bill-pressing device 334 is moved to push the bill 4 away from the bill passage 32 toward the bill entrance 11 of the box body 1 and press the bill 4 against the bill-receiving bearing board 12 in direction toward the inside of the box body 1. Because the size of the bill-pressing device 334 is slightly smaller than the bill entrance 11, the bill-pressing device 334 can be moved into the inside of the box body 1. At this time, the top edge of the bill 4 is forced against the rib 23 of the baffle 2, thereby biasing the baffle 2, and therefore the bill 4 is moved over the baffle 2 to the inside of the box body 1.

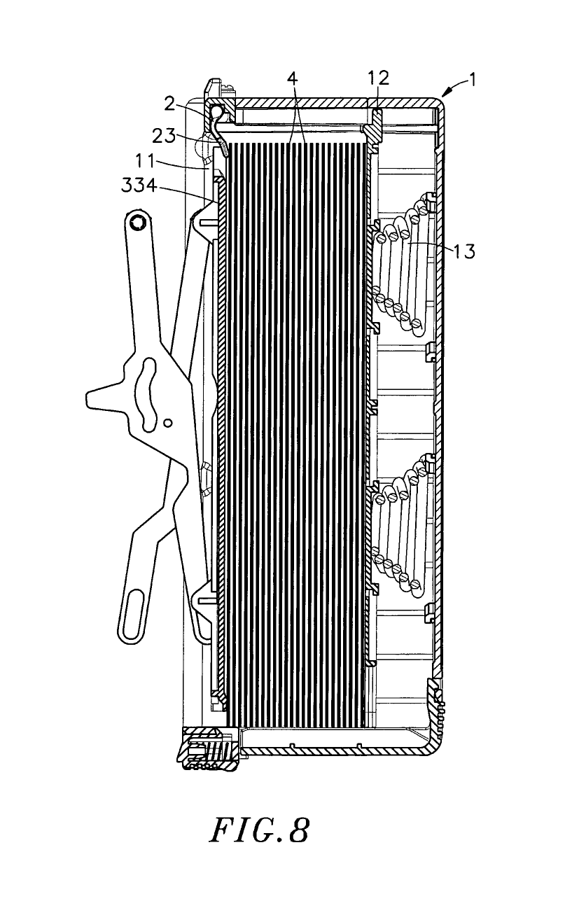

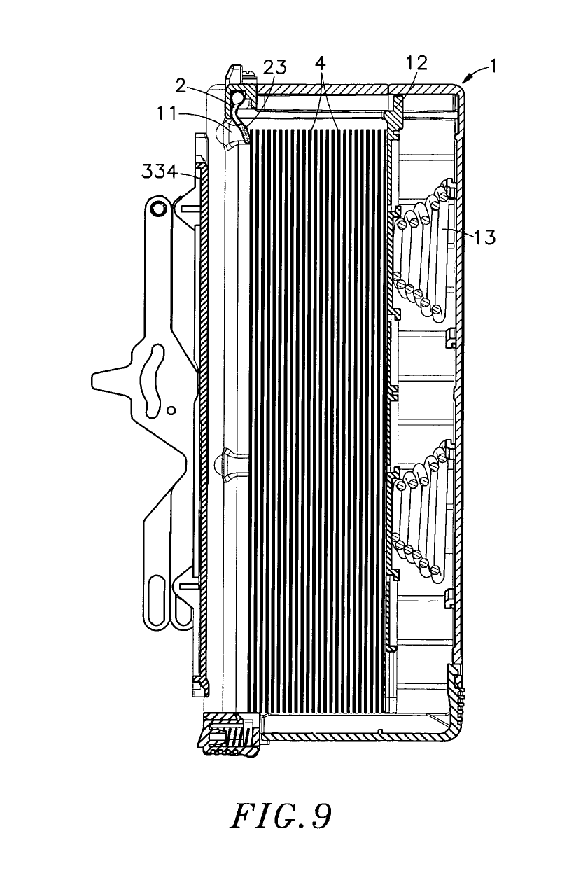

The size of the bill 4 is approximately equal to the size of the bill-receiving bearing board 12. When the bill-pressing device 334 moved the bill 4 over the baffle 2 (see FIGS. 8 and 9), the bill-pressing device 334 is returned to its former position outside the box body 1. At this time, the spring members 13 push the bill-receiving bearing board 12 toward the bill entrance 11, and therefore the bill 4 is stopped between the bill-receiving bearing board 12 and the inner surface of the bill box 1 around the bill entrance 11, and the rib 23 of the baffle 2 is pressed on the top edge of the bill 4, holding down the bill 4 in place

Referring to FIGS. 3 and 4 again, by means of using the encoder wheel 3311 and the optical sensor 3312 to count the number of turns of the bill-transfer rollers 332, the motor 331 of the bill transfer mechanism unit 33 of the bill acceptor main unit 3 is accurately controlled, and therefore the bill transfer mechanism unit 33 can transfer the bill 4 to a predetermined location accurately for enabling the recognition unit 35 to verify the authenticity and value of the bill 4. During verification, the light-emitting devices 3511 emit light through the bill 4 toward the optical sensors 3512, and the optical sensors 3512 receive the light penetrated through the bill 4, and therefore the transmission of the light is measured and compared with a reference value for determining the authenticity and value of the bill 4. The light-emitting devices 3511 can emit different wavelengths of visible light (blue light, green light, red light, etc.) and invisible light (ultraviolet light). Therefore, the recognition unit 35 is practical for the recognition of the authenticity and value of different types of paper currencies issued from different countries.

Further, the bill-pressing device 334 can be formed of a bill-pressing board, cross-linking mechanism or any other designs capable of pushing each inserted bill 4 away from the bill passage 32 toward the inside of the box body 1. Because the bill-pressing device 334 can easily be achieved by means of conventional techniques, no further detailed description in this regard is necessary.

The aforesaid recognition unit 35 further comprises at least one sampling module 352 arranged behind the sensor switches 341. The sampling module 352 could be adapted for reading and identifying anti-counterfeit characteristics and character data of a license inserted into the bill acceptor. By means of using the sampling module 352 to recognize the date of birth, name of the license holder of the license and the identification number or license number of the license, the bill acceptor can be used in an automatic vending machine for selling controlled items. Further, the bill acceptor automatically records the name and date of birth of the license holder, the license or ID number, the transaction time, the commodities purchased and other transaction-related data for further filing and search. Further, the license photographing and related data recording function of the bill acceptor in every automatic vending machine can be used with street video surveillance and security cameras to constitute a perfect criminal search network, helping the police to combat crime.

The aforesaid sampling module 352 comprises an image sensor adapted to fetch the image of the anti-counterfeit characteristics of the inserted license or bill. The image sensor can be a charge coupled device (CCD), complementary metal-oxide semiconductor (CMOS) image sensor or any suitable type image sensor. The anti-counterfeit characteristics include watermarking, steel stamp, invisible barcode, laser label, and etc.

Further, the bill insertion slot 31 and the bill passage 32 of the bill acceptor main unit 3 allow insertion of a bill 4 as well as a license. The bill transfer mechanism unit 33 of the bill acceptor main unit 3 is controllable to transfer the inserted bill 4 or license inwards toward the bill box. The bill transfer mechanism unit 33 of the bill acceptor main unit 3 is also controllable to transfer the inserted bill 4 or license in the revered direction to the bill insertion slot 31 when the inserted bill 4 or license is checked to be a counterfeit. Further, because the invention utilizes one single insertion slot, passage and transfer mechanism unit for receiving and carrying licenses and bills, the manufacturing cost of the bill acceptor is greatly lowered.

By means of the exclusive single passage 32 for bill as well as license, the user must retrieve the inserted license before insertion of a bill, therefore the invention prevents the problem that the user forgets to take back the inserted license.

The box body 1 is designed for use with the bill acceptor main unit 3 to form a bill acceptor. The bill acceptor main unit 3 can be configured to receive bills, coins and/or cards.

As indicated above, the invention provides a bill box comprising a box body 1 and a baffle 2. The box body 1 has a bill entrance 11 that faces a bill-pressing device 334 of a bill acceptor main unit 3, and a bill-receiving bearing board 12 supported on spring members 13 for bearing each received bill 4. The baffle 2 is pivotally mounted in the box body 1 at one side of the bill entrance 11, having a rib 23 pressed on the bill-receiving bearing board 12. After a bill 4 is moved by the bill-pressing device 334 to the bill-receiving bearing board 12, the baffle 2 is forced by torsional springs 22 to press the rib 23 on the bill 4 against the bill-receiving bearing board 12, holding the bill 4 positively on the bill-receiving bearing board 12.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bill acceptor comprising a bill acceptor main unit and a bill box fastened to said bill acceptor main unit, said bill box comprising a box body defining a bill entrance and a bill-receiving bearing board suspended inside said box body and movable forwards/backwards relative to said bill entrance, said bill acceptor main unit comprising an insertion slot for the insertion of a bill, a passage in communication between said insertion slot and said bill entrance, and a bill-pressing device for moving each inserted bill away from said passage through said bill entrance onto said bill-receiving bearing board, wherein:
said bill box comprises a baffle pivoted to said box body and suspending in one side of said bill entrance, said baffle having a rib that allows each bill to be moved from said passage over said baffle toward said bill-receiving bearing board by said bill-pressing device and stops each received bill on said bill-receiving bearing board.

2. The bill acceptor as claimed in claim 1, wherein said box body comprises a recessed hole adjacent to one side of said bill entrance, and a locating block mounted in said recessed hole, said locating block having two pivot holes aligned in a line; said baffle comprises two pivot pins disposed at two opposite lateral sides thereof and respectively pivotally coupled to said pivot holes of said locating block.

3. The bill acceptor as claimed in claim 2, wherein said bill box further comprises two torsional springs respectively mounted on said pivot pins of said baffle, each said torsional spring having two opposite ends respectively fastened to said locating block and said baffle.

4. The bill acceptor as claimed in claim 1, wherein said insertion slot and said passage of said bill acceptor main unit are designed for receiving and identifying a license, a bill, a coin and a card.

5. The bill acceptor as claimed in claim 1, wherein said bill box comprises spring means mounted inside said box body to support said bill-receiving bearing board and to impart a pressure to said bill-receiving bearing board toward said bill entrance.

6. The bill acceptor as claimed in claim 1, wherein said bill acceptor main unit comprises a detection unit disposed around said passage adjacent to said insertion slot adapted to detect the insertion of a bill, a bill transfer mechanism unit controllable by said detection unit to transfer each inserted bill toward said bill box, and a recognition unit adapted for identifying the authenticity and value of each inserted bill.

7. The bill acceptor as claimed in claim 6, wherein said detection unit comprises a plurality of sensor switches, a light-shielding gate controllable by said sensor switches to close/open said passage, and an anti-theft hook

8. The bill acceptor as claimed in claim 6, wherein said bill transfer mechanism unit comprises a motor, a plurality of bill-transfer rollers rotatable by said motor, a bill-transfer belt coupled to said bill-transfer rollers for carrying each inserted bill, and an encoder wheel and optical sensor means adapted for counting the revolving speed of said bill-transfer rollers.

9. The bill acceptor as claimed in claim 6, wherein said recognition unit comprises an optical recognition module, said optical recognition module comprising a plurality of light emitting devices arranged at one side relative to said passage, and a plurality of optical sensors arranged at an opposite side relative to said passage and respectively axially aimed at said light emitting devices.

10. The bill acceptor as claimed in claim 9, wherein said recognition unit further comprises at least one sampling module adapted for reading and identifying anti-counterfeit characteristics and character data of a license inserted into said insertion slot and said passage.
